(19) United States
(12) Patent Application Publication
(10) Pub. No.: US 2014/0314268 A1
(43) Pub. Date: Oct. 23, 2014

(54) PLANAR SPEAKER

(71) Applicant: Ricardo Lazzari, Chula Vista, CA (US)

(72) Inventor: Ricardo Lazzari, Chula Vista, CA (US)

(21) Appl. No.: 14/360,042

(22) PCT Filed: Dec. 3, 2012
(86) PCT No.: PCT/US2012/067597

§ 371 Date: May 22, 2014

Related U.S. Application Data
(60) Provisional application No. 61/565,762, filed on Dec. 1, 2011.
(60) Provisional application No. 61/594,696, filed on Feb. 3, 2012.

(51) Int. Cl. H04R 7/04

(52) U.S. Cl. CPC H04R 7/04
USPC 381/430; 381/423

(57) ABSTRACT

The present invention provides a low-frequency sound reproduction apparatus that includes a membrane assembly, a piston configured to drive the membrane and an adhesive layer positioned between the membrane and piston. The adhesive layer bonds the membrane to the piston, the membrane has a modulus of elasticity less than 3 GPa, and the piston has a modulus of elasticity greater than 15 GPa.

### PRIORITY

This application claims priority to U.S. Provisional Application No. 61/565,762, filed Dec. 1, 2011, the contents of which is incorporated herein by reference.

### BACKGROUND OF THE INVENTION

1. Field of the Invention

The present invention relates generally to flat membrane speakers and, in particular, to a planar speaker having a membrane optimized for low-frequency sound reproduction.

2. Description of the Related Art

Planar loudspeakers, referred to as speakers herein, which are used to reproduce low frequencies, i.e., 20-200 Hz, exist in numerous forms. However, conventional speakers are either aesthetically unacceptable for contemporary interior design or lack a true mechanical piston-like behavior, wherein all points in front of a driving piston move with the same displacement, needed for high-quality sound reproduction. Conventional membranes used in speakers to provide high-quality sound reproduction are also limited in shape. In addition, such speaker membranes can not be painted, and are typically concealed by positioning behind a grill for in-wall or in-ceiling installations.

U.S. Pat. No. 3,767,005 to Bertagni discloses a flat speaker that provides enhanced low frequency sound reproduction. Bertagni rejects high frequencies by use of a thick and relatively soft diaphragm, i.e. membrane, having a gradually-decreasing thickness to provide flexibility necessary to allow for diaphragm movement. However, the non-symmetrical nature of the diaphragm makes balancing and location of both the center of gravity and the center of elasticity of the moving assembly difficult, as necessary for low-distortion sound reproduction. Additionally, the high concentration of stress around the perimeter of the moving diaphragm of Bertagni seriously limits the linearity of the device, and reduces a maximum sound pressure level. Bertagni includes a protruding center piston that is impractical to conceal and precludes use in installations that require a completely flat front face.

U.S. Pat. No. 5,425,107 to Bertagni, et al. discloses a substantially planar diaphragm constructed from a pre-expanded cellular plastic material, such as polystyrene, in which separate sections of the diaphragm have different densities. The higher density section is designed for reproduction of high frequencies, and the lower density section is used for reproduction of low frequencies. The diaphragm of Bertagni, et al. is formed either by laminating together a pair of diaphragm members having the different densities to define a single sound producing region, to which a single voice coil assembly is coupled, or is formed as a unitary, one-piece structure having separate but contiguous sound producing regions, each with its own density material and voice coil assembly for reproducing a specified frequency range of sound. However, the higher density section does not disclose stiffness and lacks true mechanical pistonic behavior necessary for effective low-frequency reproduction.

Other flat diaphragms for low-frequency speakers use a flexible edge or surround, typically made of butyl rubber, compressed foam or similar materials, which is inadequate for hidden or concealed applications. These speakers have a flat stiff diaphragm and a rubber surround with an arched profile, similar to a conventional speaker, but having a disadvantage of high manufacturing cost and complexity, and a rounded surround cross-section. These speakers are unsuitable for concealed applications or applications in which the diaphragm membrane must be painted to match the room decor. Examples of such speaker diaphragms are provided by U.S. Pat. No. 4,198,550 to Matsuda, et al., U.S. Pat. No. 4,291,205 to Kamon, et al. and U.S. Pat. No. 5,701,359 by Guenther, et al.

U.S. Pat. No. 6,904,154 to Azima, et al. discloses a speaker that includes a member that extends transverse to a thickness thereof and is capable of sustaining bending waves over an acoustically active area of the transverse extension of the member. The member has a distribution of resonant modes and provides geometrical configuration and directional bending stiffness. Azima, et al. relies on a distributed mode principle, in which Eigenmodes, i.e. normal or natural vibration modes, are controlled by locating the voice coil off-center and choosing best-suited shapes and aspect ratios for radiating panels. The speaker of Azima, et al. is designed for mid-and-high-frequencies, but is unsuitable for broad, uniform and undistorted low-frequency reproduction.

Conventional systems fail to provide a speaker that can be hidden within walls constructed of gypsum-board, plaster or sheetrock, and provide a uniform exterior membrane that is flush with the flat wall, as needed to blend seamlessly with the interior design of a room, and also has a paintable membrane, while also overcoming sonic challenges of conventional hidden speakers.

### SUMMARY OF THE INVENTION

The present invention overcomes the above-described shortcomings of conventional low-frequency speaker designs and provides a speaker having a single exterior membrane that is sized to match surrounding wall structure, with the single exterior membrane being paintable to render the installed speaker effectively invisible.

In one embodiment, a low-frequency sound reproduction apparatus is provided that includes a membrane assembly, a piston configured to uniformly drive the membrane and an adhesive layer positioned between the membrane and piston. The adhesive layer bonds the membrane to the piston, the membrane has a modulus of elasticity less than 3 GPa, and the piston has a modulus of elasticity greater than 15 GPa.

### BRIEF DESCRIPTION OF THE DRAWINGS

The above and other objects, features and advantages of certain exemplary embodiments of the present invention will be more apparent from the following detailed description, taken in conjunction with the accompanying drawings, in which:

FIG. 1 is a rear perspective view of a round speaker membrane assembly of the present invention;

FIG. 2 provides an exploded view of the speaker membrane assembly of FIG. 1;

FIG. 3 is a perspective view of the speaker membrane assembly of FIGS. 1-2, also showing a groove for attachment of a voice coil;

FIG. 4 is a rear perspective view of a square speaker membrane assembly accordingly to another embodiment of the present invention;

FIG. 5 is a rear perspective view illustrating another embodiment of the square speaker membrane assembly of the present invention;

FIG. 6 is a front perspective view of the speaker membrane assembly of FIG. 5, also showing a supporting structure;

FIG. 7 is a rear perspective view of the speaker membrane assembly of FIG. 5, showing further details of the supporting structure;

FIG. 8 is a rear perspective view showing details of the speaker membrane assembly of FIG. 6, also showing a voice coil;

FIGS. 9-A to 9-M are results of surface particle velocity calculations for the round speaker of FIG. 1, for frequencies ranging from 20 to 475 Hz;

FIG. 10 is a velocity vs. frequency graph for a diaphragm assembly center point with a resonance frequency located at 36 Hz;

FIGS. 11-A to 11-L are results of surface particle velocity calculations for the square speaker of FIG. 4, for frequencies ranging from 20 to 250 Hz;

FIGS. 12-A to 12-L are results of surface particle velocity calculations for a rectangular speaker of another embodiment of the present invention, for frequencies ranging from 20 to 250 Hz;

FIG. 13 is a graph showing free-air impedance of the speaker of FIGS. 6-8, with a fundamental resonance frequency centered at approximately 31 Hz, and negligible non-pistonic modes; and

FIG. 14 is a graph showing characteristics of a conventional flat speaker membrane assembly, showing multiple high-amplitude impedance peaks caused by undesired vibration modes.

### DETAILED DESCRIPTION OF THE PREFERRED EMBODIMENTS

The following detailed description of preferred embodiments of the invention will be made in reference to the accompanying drawings. In describing the invention, explanation of related functions or constructions known in the art are omitted for the sake of clarity in understanding the concept of the invention that would otherwise obscure the invention with unnecessary detail.

Set forth below is a detailed description of the flat sound-radiating membrane of the present invention, with the membrane formed materials having differing predetermined stiffness.

FIG. 1 is a rear perspective view of a rear side of a round speaker membrane assembly of the present invention, showing membrane 1, preferably constructed of plastic material, typically a plastic sheet or film formed of PVC, ABS, polycarbonate or polypropylene. Other materials, such as fiberboard, foam board and resin laminates, can also be used for membrane 1, so long as a Modulus of Elasticity of the membrane material is less than 3 GPa, with internal losses matching a desired mechanical Q (Qms) of the speaker.

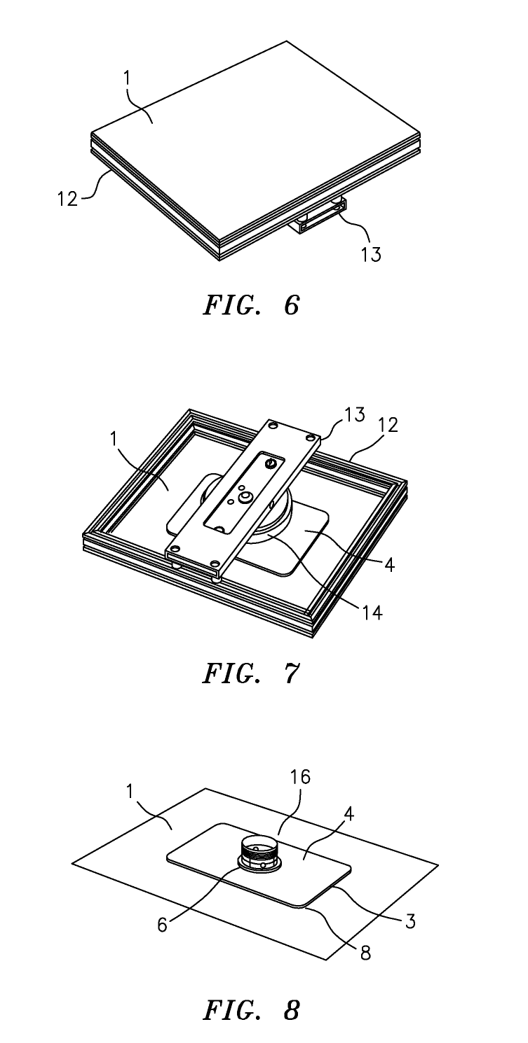

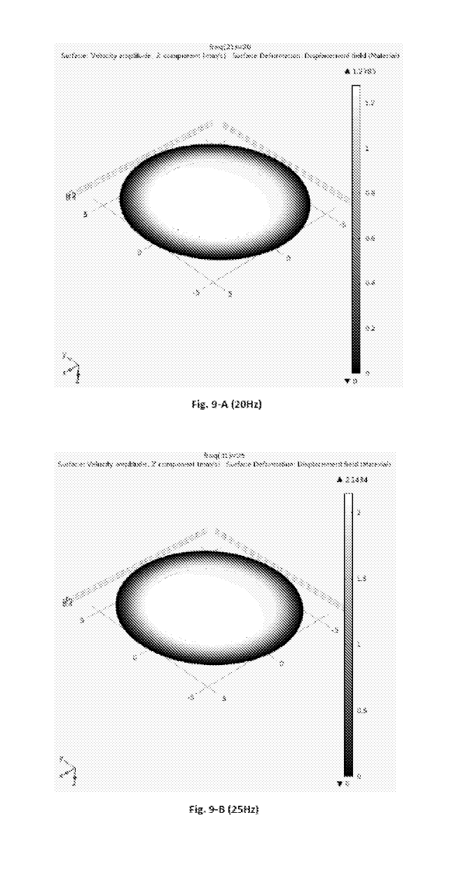

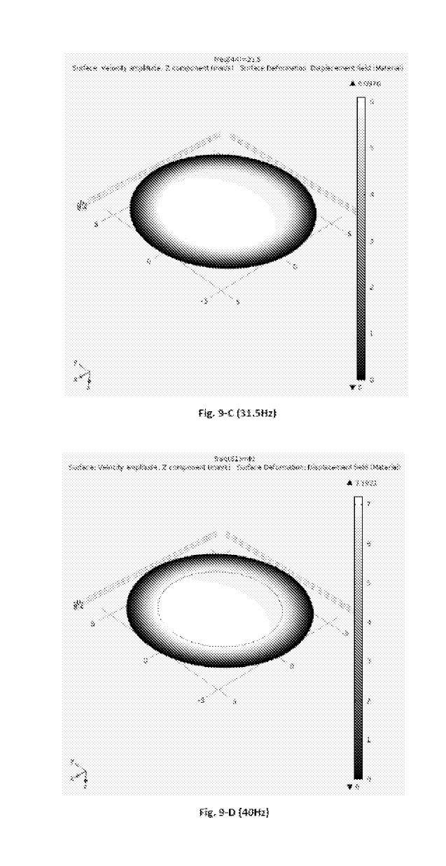

Membrane 1 is formed with a completely flat front face, with an edge 2 for attachment to a frame of the supporting structure 12, shown in FIGS. 6-7. The front side of membrane 1 is completely flat, i.e., without any protrusions, and is optimized for reproduction of low and low/mid frequencies.

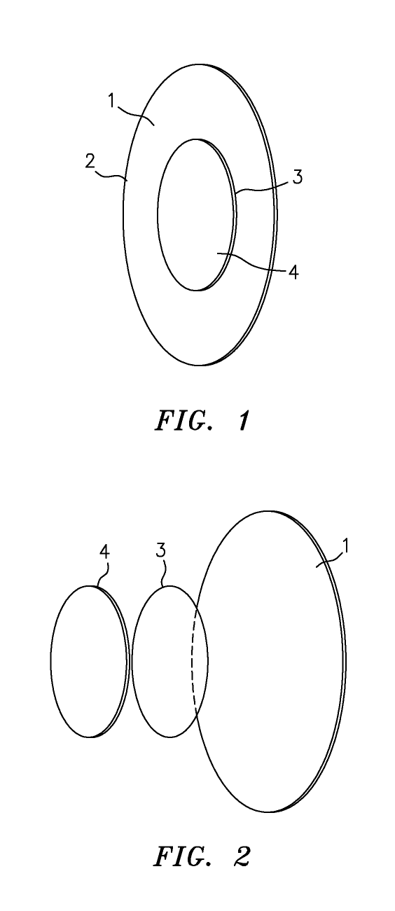

A piston 4 is affixed to the rear side of the speaker membrane assembly by adhesive layer 3, preferably formed as a separate layer, an exploded view of which is provided in FIG. 2. Depending on the specific application and mass corresponding to a desired resonance frequency, piston 4 is a solid constructed from a material such as fiberglass, carbon fiber or phenolic laminate, ceramic, aluminum or other metal, light honeycomb or other stiff cellular panels, or a multi-layer material having a stiff skin and softer, lower-density core. The material utilized to construct piston 4 must be, at minimum, ten times stiffer as compared to the material of membrane 1, with a Modulus of Elasticity (E) of piston 4 higher than 15 GPa.

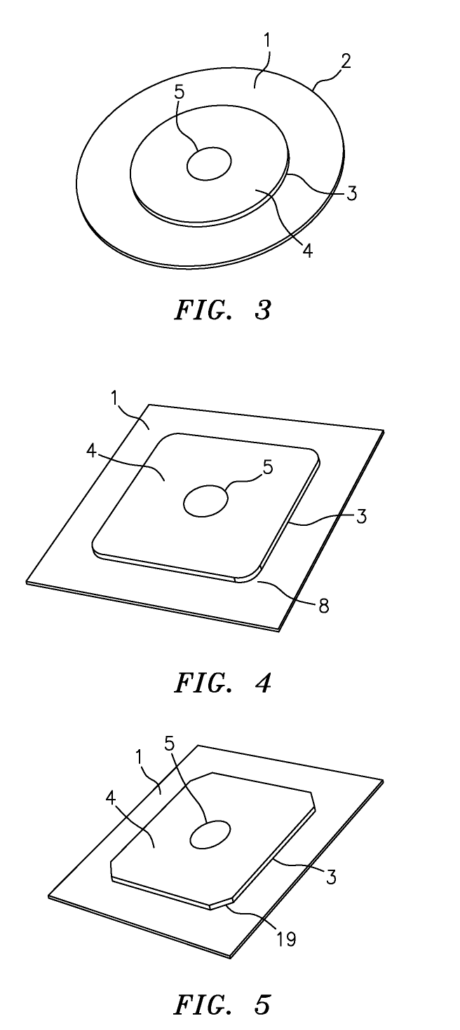

FIG. 3 is a perspective view of the speaker membrane assembly of FIGS. 1-2, showing a groove 5 for attachment of a conventional voice coil, preferably fitting the top edge of the voice coil in the groove. FIG. 4 illustrates a square speaker membrane assembly of the present invention, with membrane 1 of a square speaker provided therefrom also having a fully flat front, without any protrusions thereon. The perspective view provided in FIG. 4 is of the rear side, showing one of four rounded corners 8 of piston 4, to relieve corner tension during use of the membrane for high sound-pressure-level applications. The rounded corners 8 are provided on each vertex of a quadrilateral shaped piston and have a radius between 10 and 25 percent of a length of a longest side of the piston. Similar effect can be accomplished at generally lower manufacturing costs by straight corner cuts 19, as shown in FIG. 5, which provides a perspective view of another embodiment of the square speaker of the present invention. The straight corner cuts 19 are provided on each vertex of a quadrilateral shaped piston and have a chamfer between ten and twenty five percent of a longest side of the piston.

FIGS. 6 and 7 are front and rear perspective views, respectively, of the speaker membrane assembly of FIG. 5, showing supporting structure 12 and bridge 13 holding a magnetic circuit 14 to drive piston 4, as conventionally known in loudspeaker construction.

FIG. 8 provides a rear perspective underside view showing details of the speaker membrane assembly of FIG. 6, also showing a voice coil attachment ring 6. The design of the rectangular membrane assembly follows the same principles of the round and square versions described above, with voice-coil 16 attached to piston 4, with adhesive layer 3 positioned between the membrane 1 and the piston 4. In the embodiment of FIG. 8, the voice-coil attachment ring 6 is part of piston 4, to center and bond the voice coil 16 to the piston 4.

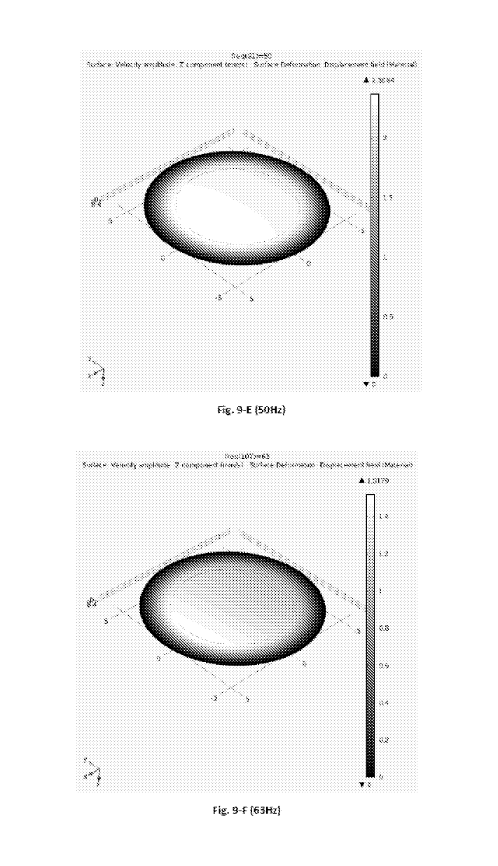

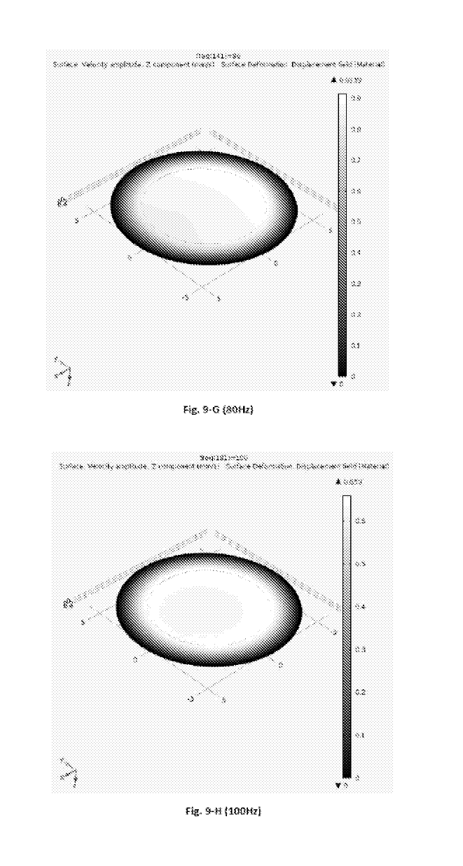

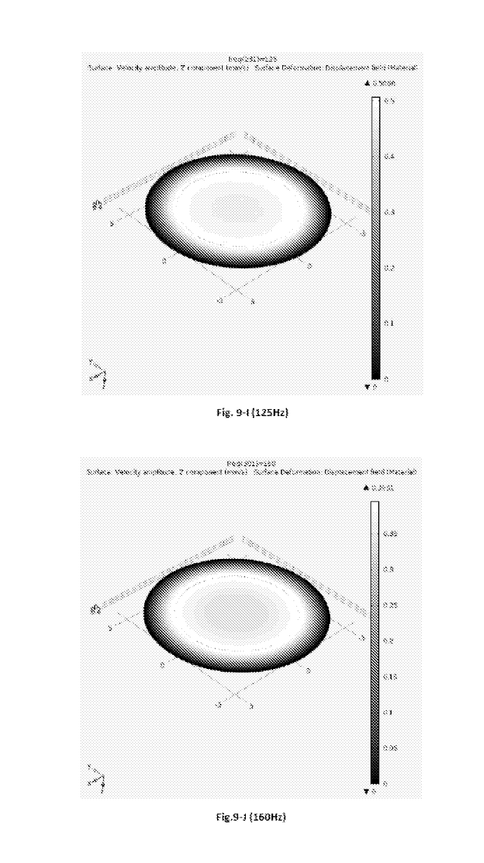

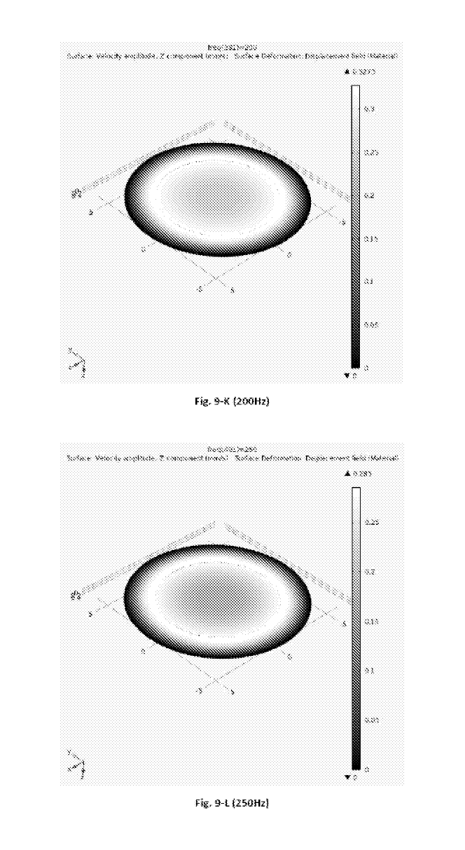

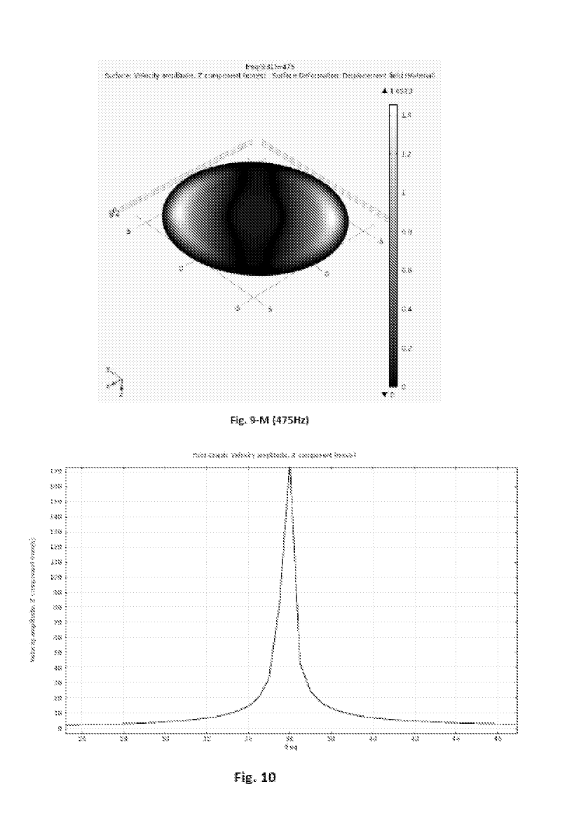

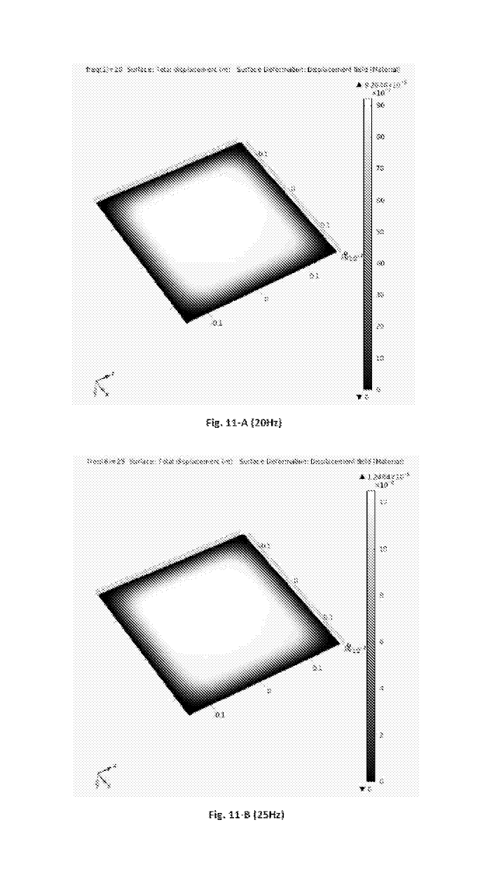

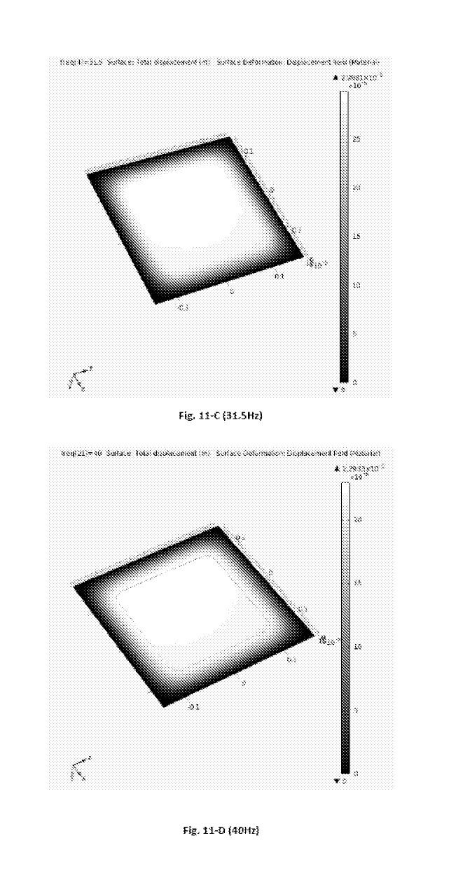

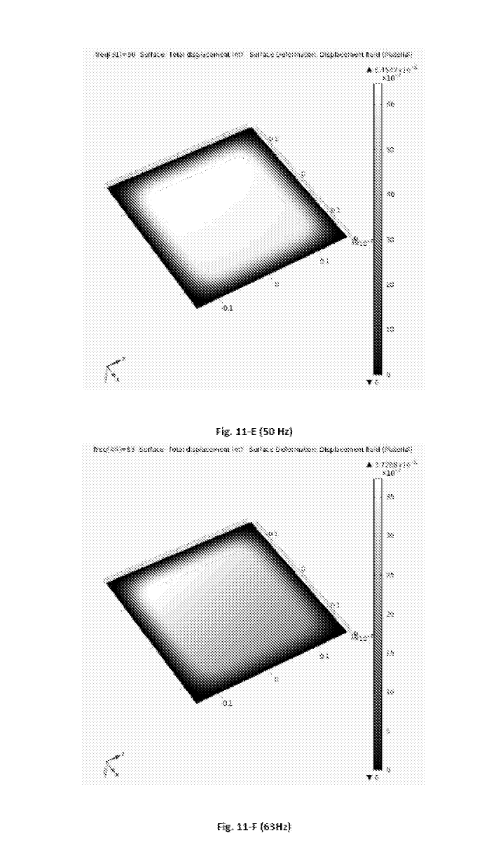

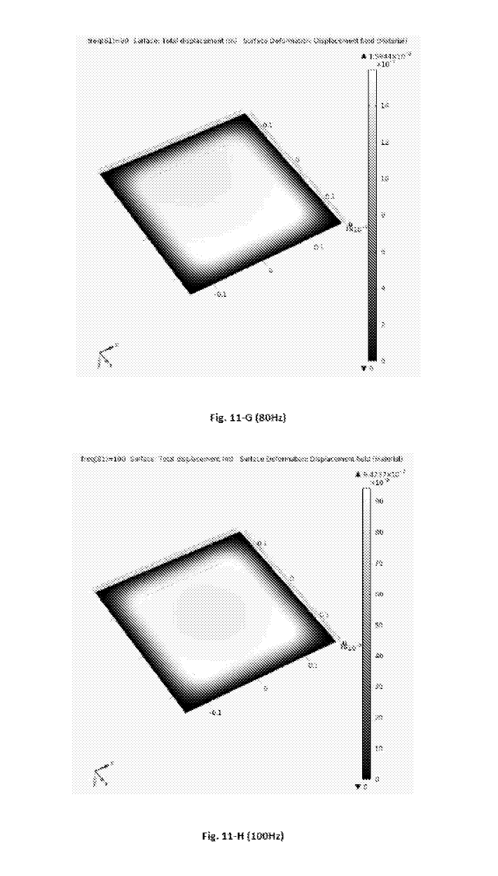

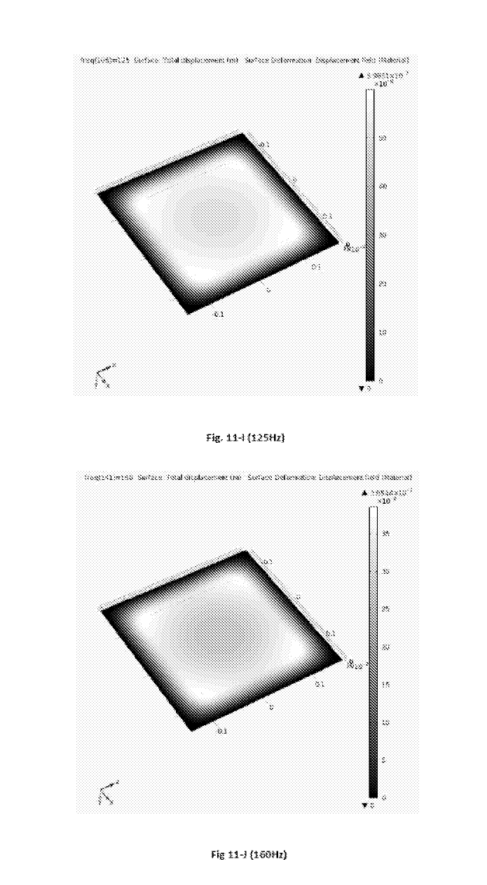

FIGS. 9-A to 9-M show surface particle velocity calculation results of finite element analysis for the round speaker construction of the embodiment of FIG. 1, with a twelve inch diameter membrane made of a PVC sheet having a uniform thickness of 1/16 of an inch, with a stiff piston constructed of an aluminum honeycomb 5 mm thick having an outside diameter of eight inches, centered on membrane 1. The edge of the membrane is constrained by attachment to a supporting structure, and a sinusoidal driving force of 0.1N RMS was applied by a two inch diameter voice coil, centered on the honeycomb piston.

For the finite element analysis, runs were performed at standard ⅓-octave ISO frequencies, with FIG. 9-A providing results for analysis conducted at 20 Hz, FIG. 9-B providing results for analysis conducted at 25 Hz, FIG. 9-C providing results for analysis conducted at 31.5 Hz, FIG. 9-D providing results for analysis conducted at 40 Hz, FIG. 9-E providing results for analysis conducted at 50 Hz, FIG. 9-F providing results for analysis conducted at 63 Hz, FIG. 9-G providing results for analysis conducted at 80 Hz, FIG. 9-H providing results for analysis conducted at 100 Hz, FIG. 9-I providing results for analysis conducted at 125 Hz, FIG. 9-J providing results for analysis conducted at 160 Hz, FIG. 9-K providing results for analysis conducted at 200 Hz, FIG. 9-L providing results for analysis conducted at 250 Hz, and FIG. 9-M providing results for analysis conducted at 475 Hz as a second normal mode, with a first normal mode being a fundamental resonance of the speaker. The analysis in FIGS. 9-A to 9-M was conducted on a flat round membrane having a twelve inch diameter, on standard ⅓-octave ISO frequencies ranging from 20 Hz to 475 Hz.

This finite element analysis confirms suitability of the flat membrane and attached stiff piston to accurately reproduce low audio frequencies, and corroborates that similar performance can be provided by membranes of different forms, including quadrilateral shaped membranes that include square and rectangular shaped membranes, in regards to which quadrilateral-shaped pistons are used. The finite element analysis shows a complete absence of undesirable out-of-phase modes that otherwise cause severe frequency-response anomalies, with only negligible piston rocking or deformation, which can be further reduced by increase of piston thickness. FIG. 9M shows the second normal mode located at 475 Hz, well above the highest frequency of interest, which confirms a broad low-frequency coverage.

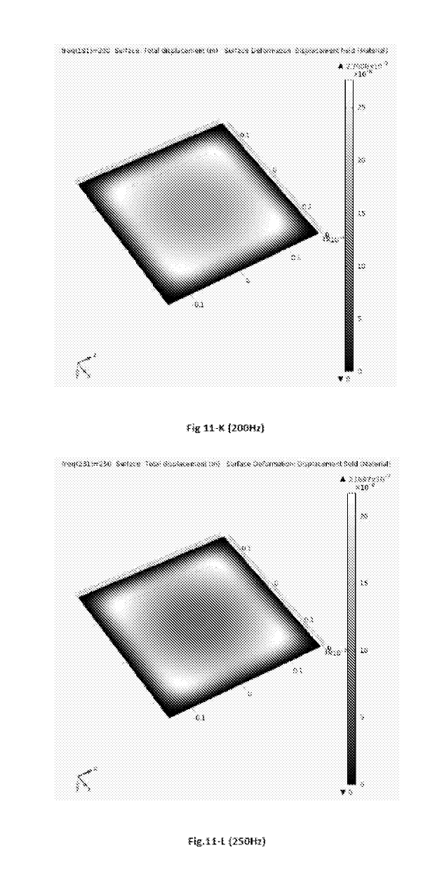

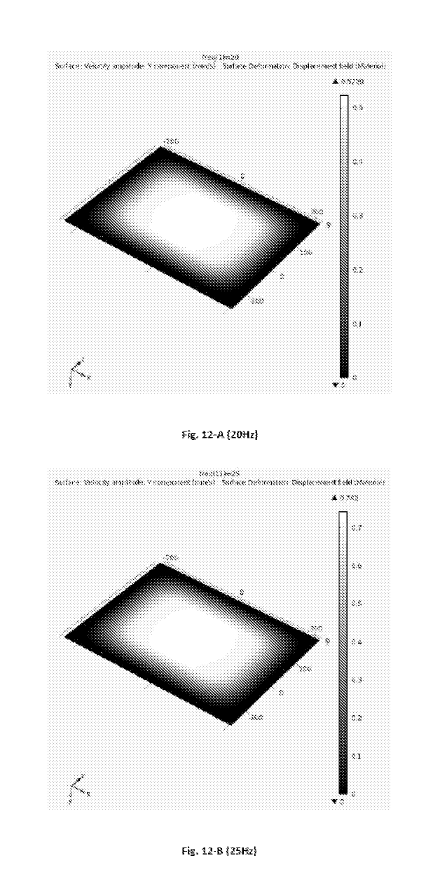

FIG. 10 is a velocity versus frequency graph for a diaphragm assembly center point having a resonance frequency at 36 Hz for the membrane assembly described above in regards to FIGS. 9A-9M. That is, FIG. 10 shows the velocity of the center point of the membrane as a function of frequency, and a natural resonant frequency of 36 Hz including the voice coil mass, without associated damping.

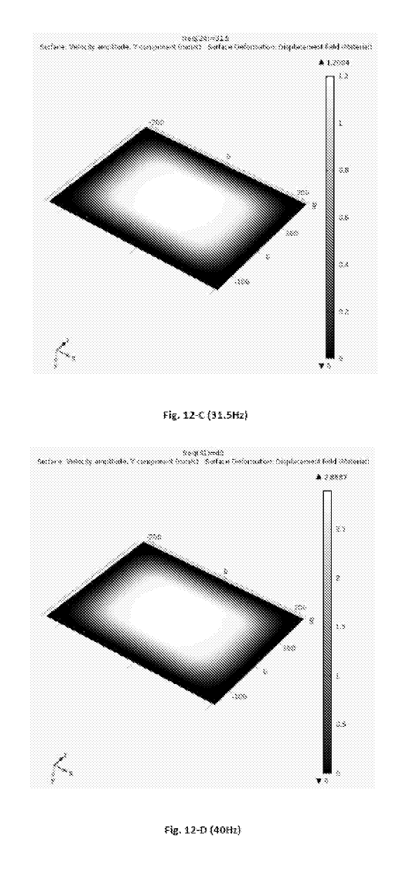

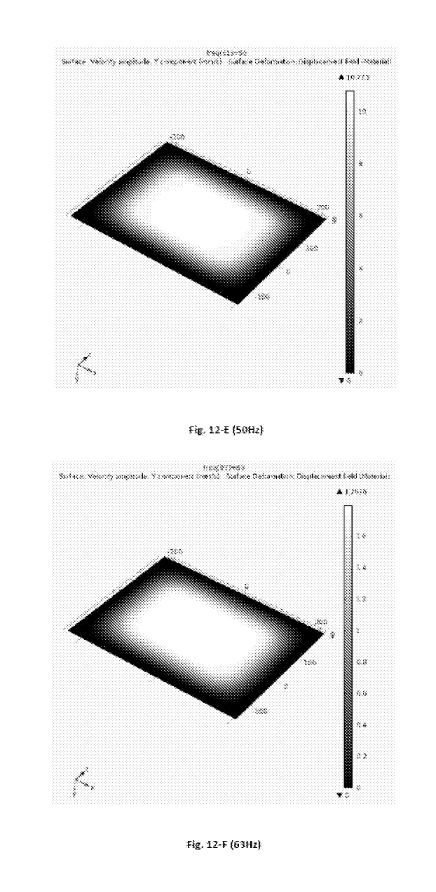

FIGS. 11-A to 11-L provide results of surface particle velocity calculations for the square speaker of FIG. 4, performed at standard ⅓-octave ISO frequencies ranging from 20 to 250 Hz, confirming similar behavior as described above, for a square membrane with one foot sides and an eight inch by eight inch honeycomb piston, each having materials similar to those described above, other than a rounded corner 8 observable in FIGS. 11-D to 11-K, confirming suitability of a flat square membrane with a piston attachment for the effective reproduction of low audio frequencies.

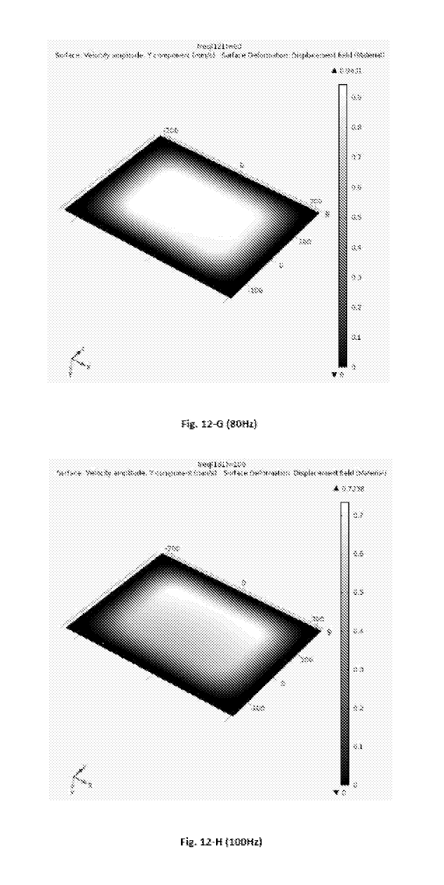

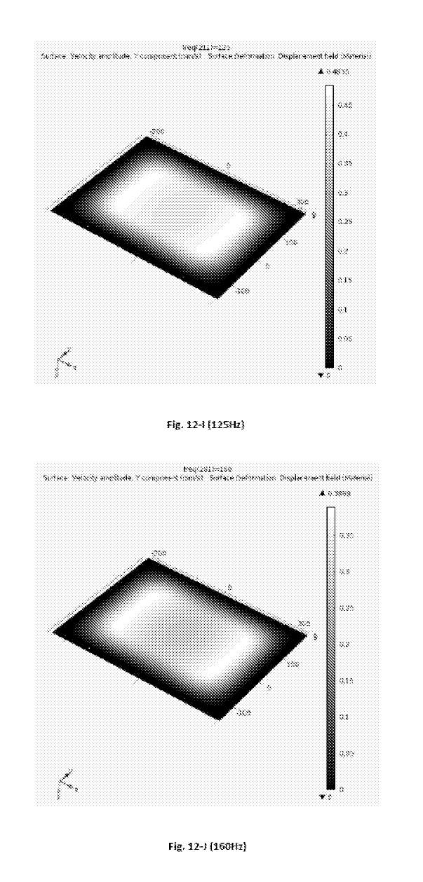

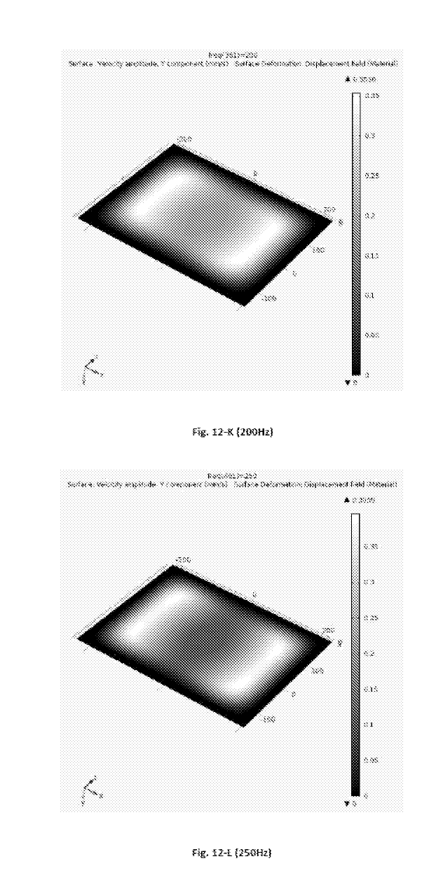

FIGS. 12-A to 12-L provide results of surface particle velocity calculations using finite element analysis for a rectangular speaker according to the embodiment of FIGS. 6-8, for frequencies ranging from 20 to 250 Hz, which indicate suitability of rectangular and other quadrilateral speakers for low-frequency applications, and show a narrower pistonic band, with the advantage of a larger surface area and higher sensitivity. The membrane in this embodiment was constructed of 1.6 mm thick PVC, with overall dimensions of the diaphragm membrane 1 are 353×435 mm, and a 160×242 mm piston. The membrane 1 and assembly are attached to a rigid aluminum frame and driven by a conventional four-layer voice coil having a two inch diameter. A 3 mm thick piston made of FR4 fiberglass laminate was bonded to membrane with a double-sided soft rubber adhesive.

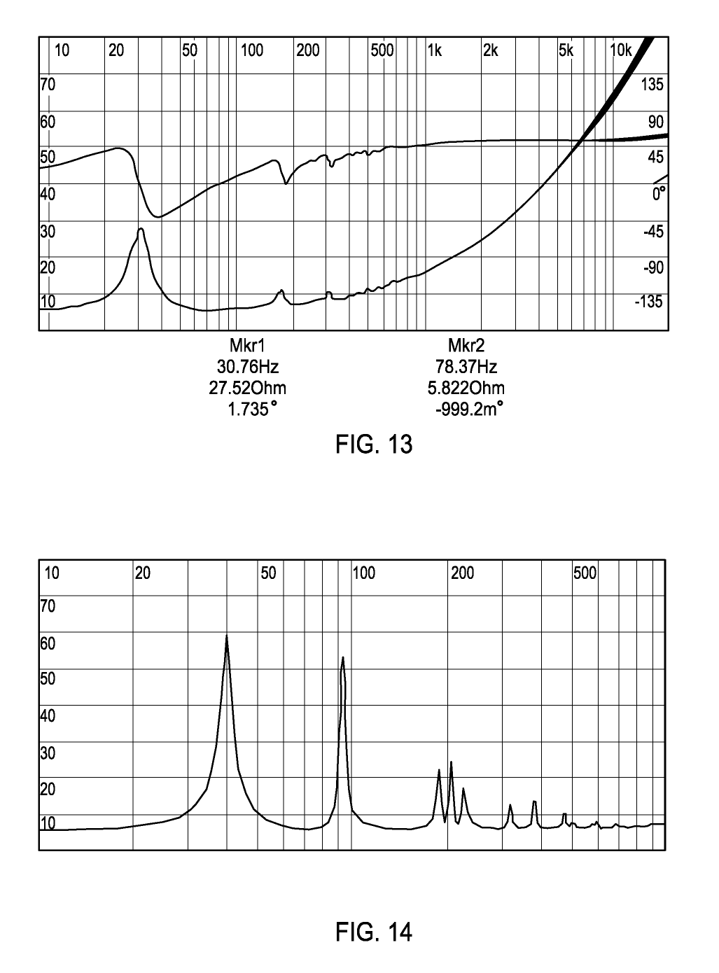

FIG. 13 is a graph showing free-air impedance of the rectangular speaker of FIGS. 6-8, with a fundamental resonance frequency centered at approximately 31 Hz, and negligible non-pistonic modes, i.e., with negligible unwanted resonances being identified by low amplitude ripples located at 180 Hz and 305 Hz on the bottom trace of FIG. 13, showing a magnitude of impedance of a finished speaker, with this impedance curve being used to detect the presence of unwanted resonance, which appear as ripples and are negligible in the present invention. In FIG. 13, MKR 1 shows the 30.76 Hz resonance frequency and the top curve shows the argument of the impedance.

FIG. 13 shows negligible amplitude of peaks above the fundamental resonance of approximately 31 Hz, and an overall shape of the impedance curve that closely matches that of a conventional speaker, thereby confirming applicability of classic loudspeaker design theory for low-frequency loudspeakers using the membrane and piston of the present invention.

The analysis results shown in FIGS. 9-13 indicate that each point of the membrane of the present invention moves in a same direction and with essentially the same velocity for frequencies within the range of interest, i.e., low audio frequencies. In contrast, conventional flat speaker membranes lack true pistionic motion exhibit multiple frequencies at which certain parts of the membrane move outwards while others simultaneously move inwards. This out-of-phase behavior causes severe and unwanted reduction of output sound pressure level, as shown through the voice coil impedance plot provided as FIG. 14.

This invention relates generally to acoustics, sound reproduction systems, and more particularly to transducers optimized for the reproduction of the lowest frequencies within the audio spectrum. Applications include but are not limited to high-fidelity, concealed speakers, home theater, background music, public address, computers, electronic gaming, headphones, sound reinforcement and paging.

While the invention has been shown and described with reference to certain exemplary embodiments of the present invention thereof, it will be understood by those skilled in the art that various changes in form and details may be made therein without departing from the spirit and scope of the present invention as defined by the appended claims and equivalents thereof.

What is claimed is:

1. A low-frequency sound reproduction apparatus comprising:
a sound-radiating membrane;
a piston configured to drive the sound-radiating membrane; and
an adhesive layer positioned between the membrane and piston, configured to bond the sound-radiating membrane to the piston.

2. The apparatus of claim 1, wherein the sound-radiating membrane has a modulus of elasticity less than 3 GPa.

3. The apparatus of claim 2, wherein the piston has a modulus of elasticity greater than 15 GPa.

4. The apparatus of claim 3, wherein the sound-radiating membrane is injection-molded on the piston.

5. The apparatus of claim 3, wherein the sound-radiating membrane is flat and round in shape.

6. The apparatus of claim 5, wherein the piston is round at an end of the piston that drives the sound-radiating member.

7. The apparatus of claim 3, wherein the sound-radiating membrane is flat and quadrilateral in shape.

8. The apparatus of claim 7, wherein the piston is quadrilateral in shape at an end of the piston that drives the sound-radiating member.

9. The apparatus of claim 8, wherein each vertex of the quadrilateral shaped piston is rounded with a radius between 10 and 25 percent of a length of a longest side of the piston.

10. The apparatus of claim 8, wherein each vertex of the quadrilateral shaped piston includes a straight cut having a chamfer between ten and twenty five percent of a longest side of the piston.

11. The apparatus of claim 1, wherein the adhesive layer has as elasticity configured to mechanically filter high frequencies.

12. The apparatus of claim 1, wherein the piston has a stiffness at least ten times higher than a stiffness of the sound-radiating membrane.

13. A method of low-frequency sound reproduction, the method comprising:
driving, via a piston, a sound-radiating membrane,
wherein an adhesive layer is positioned between the membrane and piston, and
wherein the adhesive layer is configured to bond the sound-radiating membrane to the piston.

14. The method of claim 13, wherein the sound-radiating membrane has a modulus of elasticity less than 3 GPa.

15. The method of claim 13, wherein the piston has a modulus of elasticity greater than 15 GPa.

16. The method of claim 15, wherein the sound-radiating membrane is injection-molded on the piston.
